(19) United States
(12) Patent Application Publication
(10) Pub. No.: US 2008/0116800 A1
(43) Pub. Date: May 22, 2008

(54) PLASMA DISPLAY PANEL, METHOD FOR MANUFACTURING THE SAME, AND RELATED TECHNOLOGIES

(75) Inventors: Eun Seck KANG, Seoul (KR); Won Seok MOON, Seoul (KR); Byung Gil RYU, Seoul (KR); Na Mi BYUN, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/944,137

(22) Filed: Nov. 21, 2007

(30) Foreign Application Priority Data
Nov. 21, 2006 (KR) 10-2006-0115038
Dec. 11, 2006 (KR) 10-2006-0125698

(51) Int. Cl. H01J 17/49; H01J 9/00

(52) U.S. Cl. 313/582; 445/24

(57) ABSTRACT

Disclosed are a plasma display panel with a low refractive index, to which an exhaust pipe is stably adhered, and a dielectric composition for manufacturing the plasma display panel are disclosed. The plasma display panel includes a first substrate including a first electrode and a first dielectric, a second substrate including a second electrode and a second dielectric, and a barrier rib and a sealing portion, each arranged between the first substrate and the second substrate, wherein at least one selected from the first dielectric, the second dielectric, the barrier rib and the sealing portion includes inorganic particles and a photosensitive organic silicon compound, each of which has a refractive index of 1.5 to 1.7 and is contained in an amount of 10 to 90% by weight. Disclosed is further a method for manufacturing the plasma display panel.

This application claims the benefit of Korean Patent Application No. 2006-0115038, filed on Nov. 21, 2006, and Korean Patent Application No. 2006-0125698, filed on Dec. 11, 2006, which are hereby incorporated by references as if fully set forth herein.

### BACKGROUND

1. Field

This application relates to a plasma display panel and related technologies, and at least one implementation relates to a plasma display panel including a dielectric formed through an efficient process and an exhaust pipe stably adhered thereto.

2. Discussion of Related Art

Plasma display panels (hereinafter, referred to simply as “PDPs”) are well known as emissive devices which display an image using a discharge phenomenon. Such plasma display panels are being highlighted for use as displays in image display devices having a large screen because the plasma display panels have many advantages, for instance, simple manufacture, large screen size, and rapid response speed in that it is unnecessary to provide active elements for respective cells. [0004] Referring to FIG. 1, the structure of a plasma display panel (PDP) is illustrated. As shown in FIG. 1, the PDP includes an upper glass substrate 1, a pair of sustain electrodes 9 arranged on the upper glass substrate 1, an upper dielectric layer 6 arranged on the sustain electrodes 9, and a protection layer 7 arranged on the upper dielectric layer 6. In addition, the PDP includes a lower substrate 2, an address electrode X arranged on the lower substrate 2, a lower dielectric layer 4 arranged on the address electrode X and barrier ribs 3 arranged on the lower dielectric layer 4.

The sustain electrodes 9 include a transparent electrode 9a, and a metallic bus electrode 9b which has a line width smaller than that of the transparent electrode 9a and is arranged on one edge of the transparent electrode 9a.

Wall charges resulting from plasma discharge are trapped in the dielectric layer 6, leading to maintenance of the discharge and serving as a diffusion blocking layer to inhibit sputtering of the plasma ions, and thus prevent damage to sustain electrodes 9.

The protection layer 7 arranged on the upper dielectric layer 6 prevents damage of the upper dielectric layer 6 and the sustain electrodes 9 from sputtering induced by plasma discharge and at the same time, elevates a release efficiency of secondary electrons.

The lower dielectric layer 4 and the barrier ribs 3 are formed on the lower substrate 2 in which an address electrode is formed. A phosphor layer 5 is arranged on the surface of the lower dielectric layer 4 and the barrier ribs 3. The phosphor layer 5 is excited by vacuum ultraviolet (VUV) which is generated by plasma discharge of a mixed gas fed into discharge cells, to emit UV light of a predetermined color selected from red, blue, and green. The address electrode 2 and the sustain electrode 9 are arranged such that they cross each other.

### SUMMARY

One implementation of a plasma display panel and a method for manufacturing the same substantially obviate one or more problems due to limitations and disadvantages of the related art.

One implementation of a plasma display panel includes a dielectric provided through an efficient process and an exhaust pipe stably adhered thereto, and a method for manufacturing the same.

One or more of the above items or advantages, objects, and features will be set forth in part in the description which follows and in part will become apparent to those having ordinary skill in the art upon examination of the following. Other objectives and other advantages may be realized and attained by the structure particularly pointed out in the written description and claims hereof as well as the appended drawings.

In one implementation, a plasma display panel includes a first substrate including a first electrode and a first dielectric; a second substrate including a second electrode and a second dielectric; and a barrier rib and a sealing portion, each arranged between the first substrate and the second substrate, wherein at least one selected from the first dielectric, the second dielectric, the barrier rib and the sealing portion includes inorganic particles and a photosensitive organic silicon compound, each of which has a refractive index of 1.5 to 1.7 and is contained in an amount of 10 to 90% by weight.

In another aspect, a method for manufacturing a plasma display panel includes: mixing a dielectric composition with a vehicle to prepare a photosensitive paste; applying the paste onto a substrate; and baking the paste to form at least one of a first dielectric, a second dielectric, a barrier rib and a sealing portion, wherein the dielectric composition includes or consists of inorganic particles and a photosensitive organic silicon compound, each of which has a refractive index of 1.5 to 1.7 and is contained in an amount of 10 to 90% by weight.

In yet another aspect, a plasma display panel includes: an upper panel including an upper substrate; a lower panel including a lower substrate; and an exhaust pipe fixed in an exhaust hole of the lower panel by an adhesive material containing a thermocurable or photocurable polymer.

In still another aspect, a method for manufacturing a plasma display panel includes: preparing an upper panel and a lower panel, the lower panel including a lower substrate and an exhaust hole formed on the lower substrate; applying an adhesive material containing a thermocurable or photocurable polymer onto the exhaust hole of the lower substrate; and fixing the exhaust pipe in the exhaust hole through the adhesive material.

Both the foregoing general description and the following detailed description are exemplary and explanatory and are intended to provide further explanation.

### BRIEF DESCRIPTION OF THE DRAWINGS

The accompanying drawings, which are incorporated in and constitute a part of this application, illustrate various exemplary implementations. In the drawings:

FIG. 1 is a perspective view illustrating a general plasma display panel (PDP);

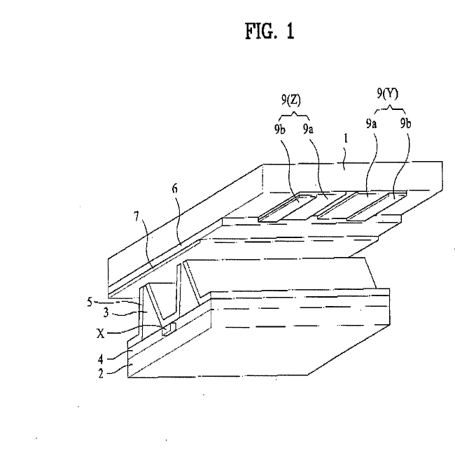

FIGS. 2A to 2D are schematic views illustrating a method for manufacturing a plasma display panel (PDP);

FIG. 3 is a cross-sectional view illustrating a plasma display panel (PDP);

FIG. 4 is a flow diagram illustrating a method for manufacturing a plasma display panel (PDP);

FIG. 5 is a perspective view illustrating another plasma display panel (PDP);

FIGS. 6 and 7 are cross-sectional views illustrating another method for manufacturing a plasma display panel (PDP);

FIGS. 8 and 9 are cross-sectional views illustrating yet another method for manufacturing a plasma display panel (PDP);

FIG. 10 is a plane view illustrating the plasma display panel (PDP) shown in FIG. 9; and

FIG. 11 is a flow diagram illustrating yet another method for manufacturing a plasma display panel (PDP).

### DETAILED DESCRIPTION

Reference will now be made in detail to examples which are illustrated in the accompanying drawings.

The various implementations may, however, be embodied in many alternate forms and should not be construed as limited to the embodiments set forth herein. Accordingly, while various modifications and alternative forms are contemplated, specific implementations thereof are shown by way of example in the drawings and will herein be described in detail. It should be understood, however, that there is no intent to limit the implementations to the particular forms disclosed, but on the contrary, this disclosure is intended to cover all modifications, equivalents, and alternatives falling within the spirit and scope of the implementations and concepts described herein and defined by the claims.

Like numbers refer to like elements throughout the description of the figures. In the drawings, the thickness of layers and regions are exaggerated for clarity.

When an element such as a layer, region or substrate is referred to as being “on” another element, it can be directly on the other element or intervening elements may also be present. It will also be understood that if part of an element, such as a surface, is referred to as “inner,” it is farther from the outside of the device than other parts of the element.

In addition, relative terms, such as “beneath” and “overlies”, may be used herein to describe one layer's or region's relationship to another layer or region as illustrated in the figures.

These terms are intended to encompass different orientations of the device in addition to the orientation depicted in the figures. Finally, the term “directly” means that there are no intervening elements. As used herein, the term “and/or” includes any and all combinations of one or more of the associated listed items.

Although the terms first, second, etc. may be used herein to describe various elements, components, regions, layers and/or sections, these elements, components, regions, layers and/or sections should not be limited by these terms.

These terms are only used to distinguish one region, layer or section from another region, layer or section. Thus, a first region, layer or section discussed below could be termed a second region, layer or section, and similarly, a second region, layer or section may be termed a first region, layer or section without departing from the teachings of the present invention.

### First Embodiment

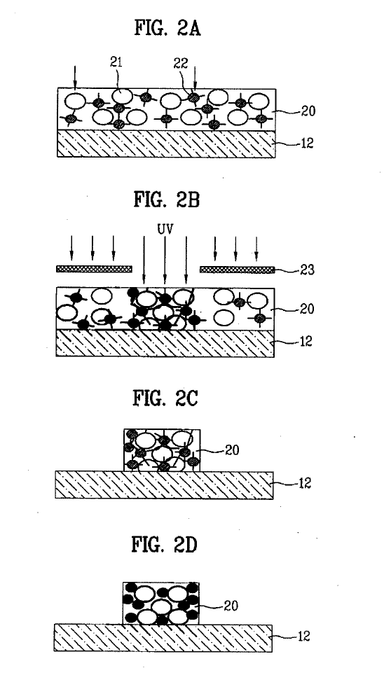

FIGS. 2A to 2D are cross-sectional views illustrating a structure of a dielectric composition of a plasma display panel (PDP).

As shown in FIG. 2A, the dielectric composition 20 of the plasma display panel (PDP) is applied onto a substrate 12 in the form of a paste. The application of the dielectric composition 20 is carried out using at least one selected from screen printing, dispensing and ink jet printing.

Such a dielectric composition includes or consists of inorganic particles 21 and a photosensitive organic silicon compound 22.

As shown in FIG. 2B, the dielectric composition 20 applied onto the substrate in the form of a paste is subjected to exposing through a mask 23.

Subsequently, the resulting dielectric composition is subjected to development as shown in FIG. 2C, and then drying and baking, as shown FIG. 2D, to remove the organic material. As a result, the dielectric composition constitutes at least one of constituent components of the plasma display panel, i.e., a first dielectric, a second dielectric, a barrier rib and a sealing portion.

During the baking, the organic material only of the dielectric composition is combusted and the silicon compound thereof remains uncombusted. For this reason, one or more constituent components having a denser structure can be formed. Accordingly, a PDP with more superior properties can be manufactured.

More specifically, the dielectric composition 20 includes or consists of 10 to 90% by weight of the inorganic particles 21 and 10 to 90% by weight of the photosensitive organic silicon compound 22.

The refractive index of the inorganic particles 21 and the photosensitive organic silicon compound 22 is in a range of 1.5 to 1.7. In addition, the inorganic particles 21 include lead-free and lead-containing glass compositions.

The photosensitive organic silicon compound 22 may be prepared by a sol-gel method. The photosensitive organic silicon compound 22 is an inorganic-organic hybrid material having a network structure in which silicon-linked oxygen atoms or crosslinkable organic monomers are crosslinked with each other, and is represented by one of Formulae I to III below:

(OR¹)ₙSi—R²ₘ(n+m=4) (I)

(OR¹)ₙSi—(X—R³ₘ(n+m=4) (II)

R⁴ₙSiClₘ(n+m=4) (III)

wherein R′ is a C₁-C₁₀ linear or branched alkyl group selected from methyl, ethyl, propyl and butyl, or a hydrogen atom obtained from hydrolysis of the alkyl group; R² is a C₁-C₄ linear or branched alkyl group, a phenyl group, a phenylalkoxy group or an amine group; n is a natural number of 1 to 4; m is an integer of 0 to 3; X is a C₃-C₆ carbon chain; R³ includes at least one selected from a vinyl group, a glycidoxy group and a methacrylic group; and R⁴ includes at least one selected from a C₁-C₁₀ linear or branched alkyl group, a hydrogen atom, a phenyl group, a phenylalkoxy group, an amine group, a vinyl group, a glycidoxy group and a methacrylic group.

The dielectric composition of the PDP is in the form of a paste having a simple composition, as compared to conventional methods employing a photosensitive organic material. After the baking, the organic material only of the dielectric composition 20 is combusted and the silicon compound thereof remains uncombusted. Based on these properties of the dielectric composition, one or more constituent components (i.e., a first dielectric, a second dielectric, a barrier rib and a sealing portion) having a denser structure can be formed. Accordingly, a plasma display panel with more superior properties can be manufactured.

Hereinafter, a method for preparing the dielectric composition for the plasma display panel (PDP) is illustrated with reference to FIGS. 2A to 2D.

First, 10 to 90 wt % of inorganic particles 21 having a refractive index of 1.5 to 1.7, and 10 to 90 wt % of a photosensitive organic silicon compound 22 having a refractive index of 1.5 to 1.7 are mixed with each other to prepare a dielectric composition.

The inorganic particles 21 include lead-free and lead-containing glass compositions and specific examples thereof include TiO₂, ZnO, B₂O₃ and BaO.

The photosensitive organic silicon compound 22 may be prepared by a sol-gel method. The photosensitive organic silicon compound 22 is an inorganic-organic hybrid material having a network structure in which silicon-linked oxygen atoms or crosslinkable organic monomers are crosslinked with each other.

The photosensitive organic silicon compound 22 can be prepared by dissolving one selected from compounds of Formulae I to III in a mixed solvent of water and alcohol, and subjecting the solution to hydrolysis and condensation in the presence of an acidic or basic catalyst.

In the compounds represented by Formulae II and III, the organic monomers which enable crosslinking between adjacent molecules by exposure include a vinyl group, a glycidoxy group and a methacrylic group, and the crosslinking is induced by organic polymerization.

The organic polymerization is carried out by the addition of a free radical organic polymerization initiator, and glycidoxy-containing monomers are organic-polymerized by ring-opening polymerization using aluminum alkoxide, titanium alkoxide, zirconium alkoxide, amine, and the like.

Specific examples of the photosensitive organic silicon compound 22 include tetramethoxysilane, tetraethoxysilane, tetrapropoxysilane, tetrabutoxysilane, vinyltriethoxysilane, vinyltrimethoxysilane, vinyltripropoxysilane, vinyltriacetoxysilane, vinyldimethoxyethoxysilane, aminopropyltriethoxysilane, aminopropyltrimethoxysilane, aminopropyltripropoxysilane, N-(3-acryloxy-2-hydroxypropyl)-3-aminopropyltriethoxysilane, N-(3-acryloxy-2-hydroxypropyl)-3-aminopropyltrimethoxysilane, 3-acryloxypropyldimethoxysilane, 3-acryloxypropyldiethoxysilane, 3-acryloxypropyldipropoxysilane, 3-(meth)acryloxypropyltrimethoxysilane, 3-(meth)acryloxypropyltriethoxysilane, 3-(meth)acryloxypropyltripropoxysilane, N-(2-aminoethyl-3-aminopropyl)trimethoxysilane (DIAMO), N-(2-aminoethyl-3-aminopropyl)triethoxysilane, N-(2-aminoethyl-3-aminopropyl)tripropoxysilane, N-(2-aminoethyl-3-aminopropyl)tributoxysilane, trimethoxysilylpropyldiethylenetriamine (TRIAMO), triethoxysilylpropyldiethylenetriamine, tripropoxysilylpropyldiethylenetriamine, tributoxysilylpropyldiethylenetriamine, 2-glycidoxyethylmethoxysilane, 3-glycidoxypropyltrimethoxysilane, 3-glycidoxypropyltriethoxysilane, 2-glycidoxypropyltrimethoxysilane, 2-glycidoxypropyltriethoxysilane, 2-glycidoxyethylmethyldimethoxysilane, 2-glycidoxyethylmethyldiethoxysilane, 3-glycidoxyethylmethyldimethoxysilane, 3-glycidoxypropylethyldimethoxysilane, 3-glycidoxypropylethyldiethoxysilane, 2-glycidoxypropylethyldiethoxysilane, 2-glycidoxypropylethyldimethoxysilane, 2-(3,4-ethoxycyclohexyl)ethyltrimethoxysilane, 2-(3,4-ethoxycyclohexyl)ethyltriethoxysilane, ethyltrimethoxysilane, methyltriethoxysilane, 3-chloropropyltrimethoxysilane, 3-chloropropyltripropoxysilane, 2-chloropropyltrimbutoxysilane, phenyltrimethoxysilane, phenyltriethoxysilane, 3,3,3-trifluoropropyltrimethoxysilane, dimethyldimethoxysilane, 3-chloropropylmethyldimethoxysilane, methyltrichlorosilane, ethyltrichlorosilane, phenyltrichlorosilane, vinyltrichlorosilane, hexyltrichlorosilane and decyltrichlorosilane.

A method for preparing the photosensitive organic silicon compound 22 includes dissolving one selected from compounds of Formulae I to III in a mixed solvent of water and alcohol, and subjecting the solution to hydrolysis and condensation in the presence of an acidic or basic catalyst. The dielectrics are manufactured by gelation in which high molecular-weight oxide undergoes sol-gel transition through a series of hydrolysis and condensation of silane compounds represented by Formulae I and II.

In a case where the compound represented by Formula II includes a vinyl group, a glycidoxy group and a methacrylic group as organic monomers enabling crosslinking between adjacent molecules, and the method further includes organic polymerization.

When the silicone-substituted organic group is a vinyl group and a methacrylic group (preferably, methacryloxy group), the organic polymerization is carried out by addition of a free-radical cationic/anionic thermal-photopolymerization initiator. Glycidoxy-containing monomers can be organic-polymerized by ring-opening polymerization using aluminum alkoxide, titanium alkoxide, zirconium alkoxide, amine, and the like.

The photosensitive organic silicon compound 22 may vary the structure and properties of final components, according to the type of the organic material. The organic material functions as a network former and a network modifier in a network structure in which oxygen atoms are crosslinked with each other.

For example, an organic material, such as phenyl or amine, incapable of binding to other organic monomers or inorganic network structures functions as a network modifier in the photosensitive organic silicon compound 22.

In the case where an organic material added is a glycidoxy group, a methacrylic group or a vinyl group, the organic material functions as a crosslink agent which binds to another organic material in other organic monomers or inorganic network structures, resulting in formation of new bonds.

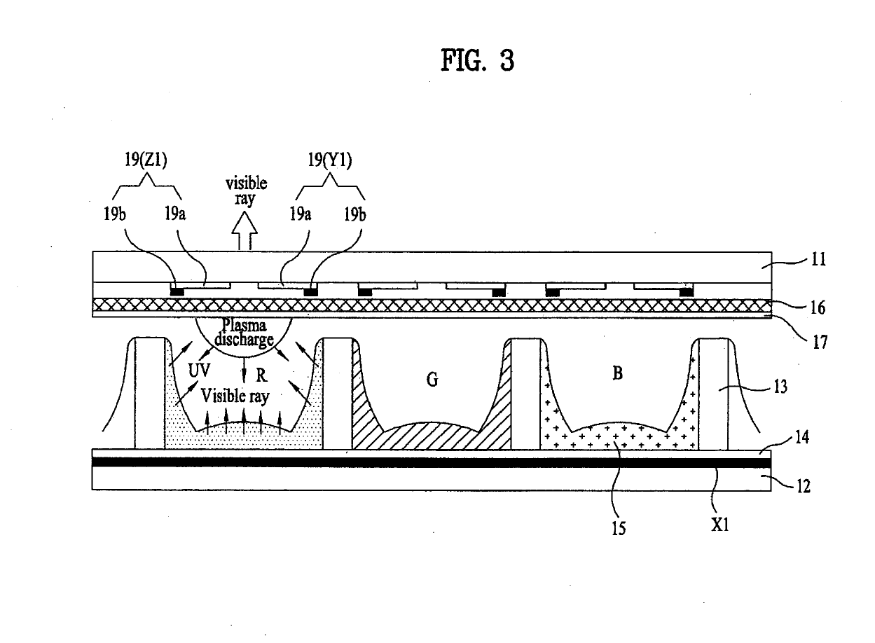

As shown in FIG. 3, the plasma display panel of FIG. 3 includes a first dielectric 16, barrier ribs 13, a second dielectric 14 and a sealing portion (not shown). The dielectric composition used for the upper dielectric (i.e., the first dielectric 16), the barrier ribs 13 composed of a dielectric, the lower dielectric (i.e., the second dielectric 14), and the sealing portion 17 composed of a dielectric has a refractive index of 1.5 to 1.7, and includes or consists of 10 to 90 wt % of inorganic particles and 10 to 90 wt % of a photosensitive organic silicon compound.

The inorganic particles include lead-free and lead-containing glass compositions.

The photosensitive organic silicon compound 22 may be prepared by a sol-gel method. The photosensitive organic silicon compound 22 is an inorganic-organic hybrid material having a network structure in which silicon-linked oxygen atoms or crosslinkable organic monomers are crosslinked with each other and is represented by at least one of Formulae I to III above.

The composition for the first dielectric 16 is mixed in the form of a powder having a particle diameter of 1 to 1.5 μm with a vehicle, to prepare a photosensitive paste having a viscosity of 40,000 to 60,000 cps, the paste is applied onto the entire surface of the first substrate 11 and the resulting structure is baked at 480° C. or less, to complete formation of the first dielectric 16.

The composition used for the barrier ribs 13, the second dielectric 14 and the sealing portion 18 is mixed in the form of a powder having a particle diameter of 1 to 1.5 μm with a vehicle to prepare a photosensitive paste having a viscosity of 40,000 to 60,000 cps, the paste is applied onto the entire surface of the second substrate 12 and the resulting structure is patterned and baked at 480° C. or less, to complete formation of the barrier ribs 13, the second dielectric 14 and the sealing portion 18.

The glass composition for the barrier ribs 13, the second dielectric 14 and the sealing portion 18 may further comprise 10 to 20 wt % of SiO₂ or TiO₂ which functions as a filler and a refractive-index enhancer.

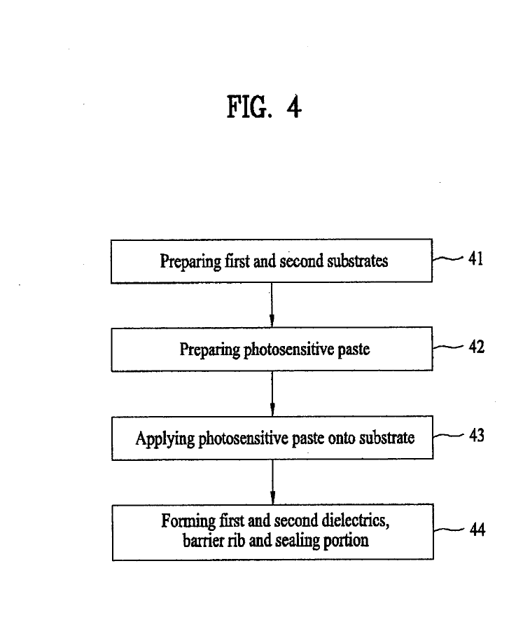

FIG. 4 is a flow diagram illustrating a method for manufacturing a plasma display panel.

As shown in FIG. 4, the method includes: preparing a first substrate including a first electrode and a first dielectric, and a second substrate including a second electrode, a second dielectric, barrier ribs and a sealing portion (41); and mixing a dielectric composition including or consisting of inorganic particles and a photosensitive organic silicon compound, both of which have a refractive index of 1.5 to 1.7 and are used in an amount of 10 to 90 wt %, with a vehicle to prepare a photosensitive paste (42).

Subsequently, the method further includes applying the paste onto a substrate (43) and baking the paste to form at least one of the first and second dielectrics, the barrier ribs and the sealing portion (44).

The preparation of the photosensitive paste (42) is carried out by mixing inorganic particles and a photosensitive organic silicon compound, both of which have a refractive index of 1.5 to 1.7 and are used in an amount of 10 to 90 wt %. To improve the flowability of the mixture, 0 to 10 wt % of SiO₂ may be further added to the mixture.

The dielectric composition, in which the ingredients are mixed with each other in accordance with an afore-mentioned composition, is fused at a high temperature, dipped in water at ambient temperature or rapidly cooled using a twin-roll in a dry-type, grinded with a grinder, mixed with a filler, if necessary, and dried, thereby giving a powder.

If necessary, the filler may be used in an amount of 0 to 20 parts by weight, with respect to 100 parts by weight of the dielectric composition.

Then, 70 to 90 wt % of the powder thus prepared is mixed with 10 to 30 wt % of the vehicle. The vehicle includes 0 to 15 wt % of a binder, 0 to 80 wt % of a solvent and 0 to 5 wt % of a dispersant so that the mixing and printing of powdery particles can be promoted. Examples of suitable solvents include alcohol, glycol, propylene glycol ether, propylene glycol acetate, ketone, BCA, xylene, terpineol, texanol and water. An acrylic dispersant with superior dispersability is generally used as the dispersant.

The inorganic particles include lead-free and lead-containing glass compositions and specific examples thereof include TiO₂, ZnO, B₂O₃ and BaO.

The photosensitive organic silicon compound is prepared by a sol-gel method. The photosensitive organic silicon compound is an inorganic-organic hybrid material having a network structure in which silicon-linked oxygen atoms or crosslinkable organic monomers are crosslinked with each other.

The photosensitive organic silicon compound is prepared by dissolving one selected from compounds represented by Formulae I to III in a mixed solvent of water and alcohol, and hydrolyzing and condensing the solution in the presence of an acidic or basic catalyst.

The application of the photosensitive paste onto the substrate (43) is carried out by applying the paste onto the entire surface of one or more layers constituting at least one of a first dielectric, a second dielectric, barrier ribs, and a sealing portion using at least one selected from screen printing, dispensing and ink jet printing, and baking the layers at 540° C. or less, thereby forming at least one selected from the first dielectric, the second dielectric, the barrier ribs, and the sealing portion. The sealing portion may be formed by applying the paste onto either the first substrate or the second substrate.

### Second Embodiment

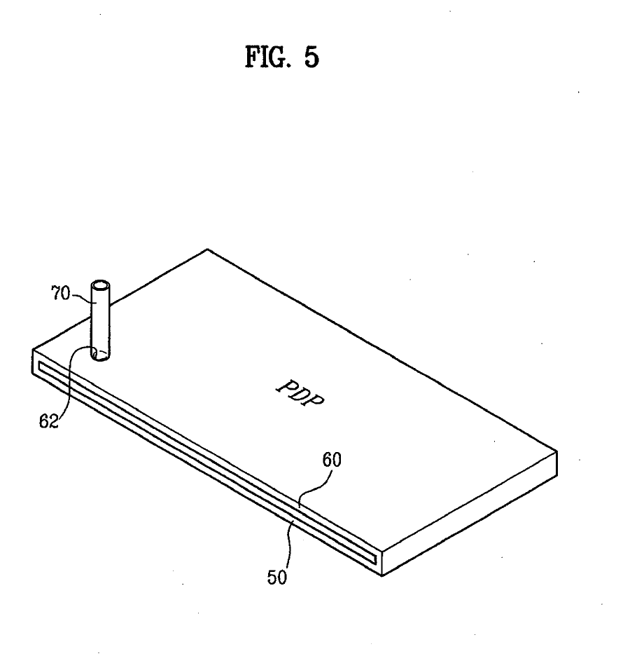

FIG. 5 shows a structure of a plasma display panel including an upper panel 50, a lower panel 60 and an exhaust pipe arranged on the lower panel 60.

More specifically, the exhaust pipe 70 to exhaust an impurity gas generated during exhausting and other processes and to feed a functional discharge gas is fixed around an exhaust hole 62 which is arranged on the lower substrate of the lower panel 60 of the plasma display panel.

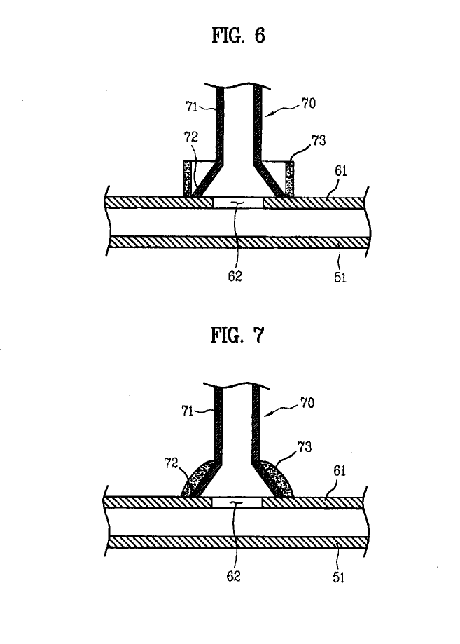

Hereinafter, a process for installing the exhaust pipe 70 in the PDP will be illustrated with reference to FIGS. 6 and 7.

The PDP has a structure in which a barrier rib is interposed between an upper substrate 51 and a lower substrate 61. Exhaust of the impurity gas which remains between the two substrates 51 and 61 is prerequisite for introduction of a functional gas into the space therebetween.

The exhaust pipe 70 is installed to discharge the gas present between the two substrates 51 and 61 and inject a functional gas therebetween and is composed of a cylindrical pipe 71 and a junction portion 72.

As shown in FIG. 6, the exhaust pipe 70 is installed such that the junction portion 72 is arranged on the exhaust hole 62 of the lower substrate 61 and a frit ring 73 having a cylindrical shape is arranged around the junction portion 72. The frit ring 73 has a cylindrical structure having an internal diameter equal to or larger than the external diameter of the junction portion 72 of the exhaust pipe 70.

Then, the PDP is subjected to heat-treatment. As a result, the frit ring 73 allows the junction portion 72 of the exhaust pipe 70 to be integrally bound to the exhaust hole 62, as shown in FIG. 7.

That is to say, when the exhaust pipe 70 is baked at about 450° C., the frit ring 73 is fused and then serves as an adhesive agent, allowing the junction portion 72 of the exhaust pipe 70 to be adhered to the side surface of the exhaust hole 62 of the lower substrate 61.

However, since the frit ring 73 is composed of a mixture of a glass ingredient and a binder, the binder therein is thermally decomposed during heating at a baking temperature to generate an impurity gas, which is an internal contaminant of PDPs. In addition, a foam-like impurity gas is generated in the baked frit ring 73 and leaks may occur in the sealed junction portion.

Furthermore, when the frit ring 73 is fused, it undergoes a deterioration in viscosity. For this reason, the fused frit ring partially flows into the exhaust hole 62 and makes the exhaust hole clogged, or cannot be evenly adhered to the exhaust pipe 70. Since the frit ring 73 has at least a 10-fold greater thermal expansion coefficient than that of the lower substrate 61, cracks may occur in the following process of the heating-exhaust or by slight impacts.

### Third Embodiment

Hereinafter, a bonding structure to solve problems of the case where the exhaust pipe 70 is adhered to the exhaust hole 72 with the use of the frit ring 73 will be illustrated.

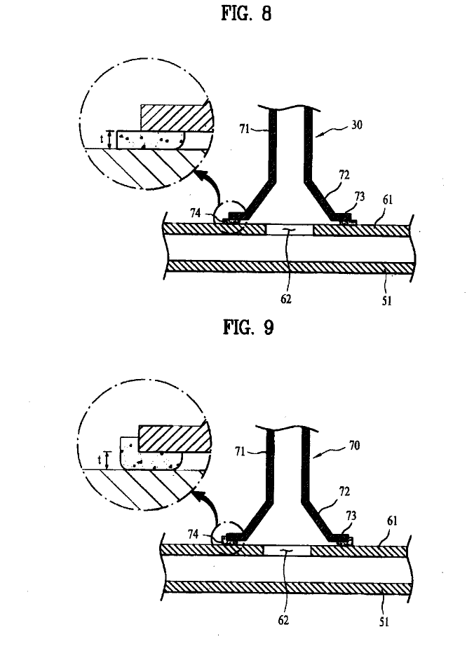

As shown in FIG. 8, the exhaust pipe 70 is fixed in the exhaust hole 62 of the lower substrate 61 with an adhesive agent containing a thermocurable or photocurable polymer.

As mentioned above, the exhaust pipe 70 has a structure in which a funnel-shaped first junction portion 72 is integrally formed with the cylindrical pipe 71. A second junction portion 73 is arranged under the first junction portion 72 such that it extends from the junction portion 72 in a bent state. The second junction portion 73 has preferably a side in contact with the lower substrate 61.

Hereinafter, an explanation of an exemplary embodiment in which the second junction portion 73 is adhered to the lower substrate 61 will be given. However, an exhaust pipe having one junction portion 72 may be directly adhered to the substrate 61, as shown in FIG. 6.

The second junction portion 73 of the exhaust pipe 70 has a part joined onto the lower substrate 61 such that the part runs parallel to the lower substrate 61. An adhesive material 74 is applied along the circumference of the second junction portion 73 of the exhaust pipe 70.

The adhesive material 74 is a photocurable or thermocurable coating material and includes at least one selected from an ultraviolet-curable epoxy or acrylic resin and an organic-inorganic hybrid composite composition.

As shown in FIG. 9, the adhesive material 74 is fused and cured between the lower substrate 61 and the junction portion 73 of the exhaust pipe 70.

The adhesive material 74 is applied to a thickness t of 0.3 to 8 mm in an amount less than 2 cc. The reason for the thickness range as defined above is that when the thickness t is less than 0.3 mm, the exhaust pipe 70 cannot be stably fixed on the lower substrate 61, and when the thickness t exceeds 8 mm, the adhesive material 74 flows into the exhaust hole 62 of the lower substrate 61 during baking and thus makes the hole clogged.

Accordingly, a coating material that can be thermally cured at a baking temperature of 200° C. or less is used as the adhesive material 74, and the exhaust pipe 70 can be firmly fixed on the lower substrate 61 by performing even simple exposure exclusively. A more detailed explanation of photocuring through baking and exposure will be given below.

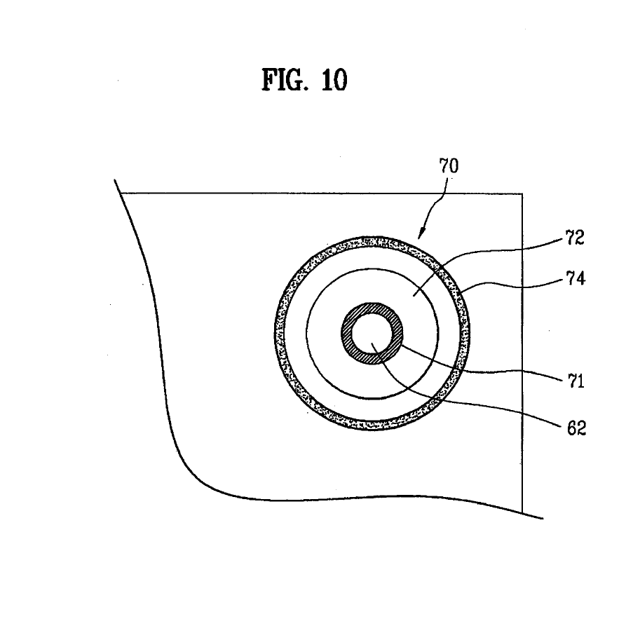

FIG. 10 is a plane view showing a state in which the exhaust pipe 70 is adhered onto the lower substrate 61. As shown FIG. 10, the exhaust pipe 70 is fixed in the exhaust hole 62 which is formed in a predetermined region of the lower substrate 61 of the plasma display panel, and based on the exhaust hole 62 as a center, the cylindrical pipe 71 is formed in a circumferencial shape along the external diameter of the exhaust pipe 70, the junction portion 72 (73) is formed in a circumferencial shape along the external diameter of the cylindrical pipe 71, and the adhesive material 74 is formed in a circumferencial shape along the external diameter of the junction portion 72 (73).

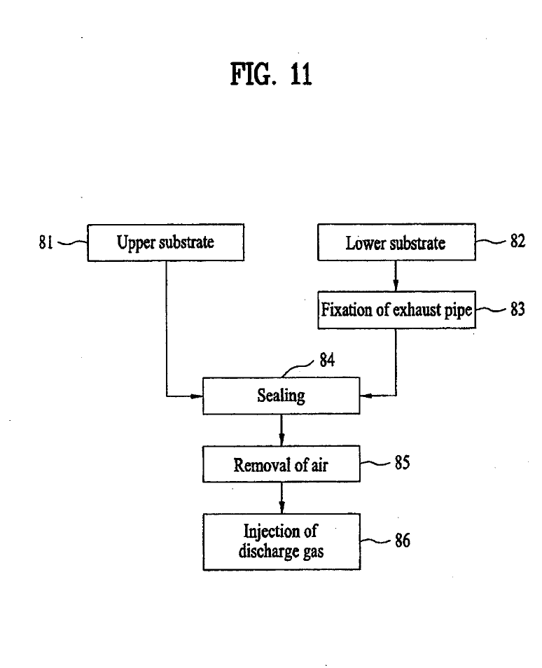

Hereinafter, a method for manufacturing the plasma display panel according to the embodiment will be illustrated with reference to FIG. 11.

As shown in FIG. 11, an upper substrate is first prepared (81). The upper substrate includes a plurality of a pair of sustain electrodes including a bus electrode and a sustain electrode, and an upper dielectric layer and a protection layer arranged over the electrodes.

Then, a lower substrate is prepared (82). The lower substrate includes address electrodes and sustain electrodes arranged which are arranged opposite each other. In addition, the lower substrate includes a lower dielectric layer arranged over the address electrodes and an exhaust hole.

Then, the exhaust pipe is fixed on the exhaust pipe using the adhesive material (73).

Subsequently, the fixing of the exhaust pipe is carried out by thermal-curing using a furnace or photocuring using an exposure system. A detailed explanation of such a process will be given below.

The fixation of the exhaust pipe using a furnace is carried out by applying an adhesive material to an exhaust hole onto a lower substrate, fixing an exhaust pipe thereon, and heating the resulting structure in a furnace.

At this time, the structure is thermally cured in the furnace at 200° C. or less. Since such a baking temperature is lower than that of a conventional thermal-curing method using a frit ring, it ensures low-temperature baking, and thus enables prevention of deformation and distortion of a glass substrate which is used as a material for the lower substrate.

The fixation of the exhaust pipe using an exposure system is carried out by applying the adhesive material to an exhaust hole on a lower substrate, fixing an exhaust pipe thereon, and photocuring the adhesive material with an exposure system.

At this time, the exposure to light is carried out using a 320-360 nm lamp selected from a mercury lamp, a chemical lamp, a carbon arc lamp, a metal halide lamp and a tungsten lamp.

The fixation of the exhaust pipe using the exposing process provides a more convenient and simpler method and eliminates the necessity of high-temperature heating on a glass substrate used as a base, thus realizing the fixation of the exhaust pipe on the lower substrate through a relatively simple process.

The adhesive material used for the fixation method as mentioned above is a thermocurable or photocurable coating material and includes at least one selected from an ultraviolet-curable epoxy or acrylic resin and an organic-inorganic hybrid composite composition.

The adhesive material enables baking at a low temperature of 200° C. or less and photocuring and has a high viscosity of 150 mPa·s or more. Accordingly, the adhesive material does not flow into the exhaust hole during baking and exposing, thus causing no clogging of the exhaust hole.

Then, the upper substrate and the lower substrate are sealed and joined with each other (84).

The gases present in the PDP are heated and exhausted to the outside using a pump (85).

A discharge gas such as Xe, Ne or Ar is fed through the exhaust pipe into the PDP (86) and the middle region of the exhaust pipe is fused with a torch and sealed together to complete manufacture of the PDP.

It will be apparent to those skilled in the art that various modifications and variations can be made without departing from the spirit or scope of the disclosure. Thus, it is intended that the disclosure covers various modifications and variations of the implementations described by this application.

What is claimed is:

1. A plasma display panel comprising:
a first substrate including a first electrode and a first dielectric;
a second substrate including a second electrode and a second dielectric; and
a barrier rib and a sealing portion, each arranged between the first substrate and the second substrate,
wherein at least one selected from the first dielectric, the second dielectric, the barrier rib and the sealing portion includes inorganic particles and a photosensitive organic silicon compound, each of which having a refractive index of 1.5 to 1.7, and each of which being included in an amount of 10 to 90% by weight.

2. The plasma display panel according to claim 1, wherein the inorganic particles include lead-free and lead-containing glass compositions.

3. The plasma display panel according to claim 1, wherein the photosensitive organic silicon compound is prepared by a sol-gel method and is an inorganic-organic hybrid material having a network structure in which silicon-linked oxygen atoms or crosslinkable organic monomers are crosslinked with each other.

4. The plasma display panel according to claim 1, wherein the photosensitive organic silicon compound is prepared by dissolving one selected from compounds of the following Formulae I to III in a mixed solvent of water and alcohol, and subjecting the solution to hydrolysis and condensation in the presence of an acidic or basic catalyst:
(OR¹)ₙSi—R²_{M}(n+m=4) (I)
(OR¹)ₙSi—(X—R³)ₘ(n+M=4) (II)
R⁴ₙSiClₘ(n+m=4) (III)
wherein R′ is a C₁-C₁₀ linear or branched alkyl group selected from methyl, ethyl, propyl and butyl, or a hydrogen atom obtained from hydrolysis of the alkyl group;
R² is a C₁-C₄ linear or branched alkyl group, a phenyl group, a phenylalkoxy group or an amine group;
n is a natural number of 1 to 4;
m is an integer of 0 to 3;
X is a C₃-C₆ carbon chain; R³ includes at least one selected from a vinyl group, a glycidoxy group and a methacrylic group; and
R⁴ includes at least one selected from a C₁-C₁₀ linear or branched alkyl group, a hydrogen atom, a phenyl group, a phenylalkoxy group, an amine group, a vinyl group, a glycidoxy group and a methacrylic group.

5. A method for manufacturing plasma display panel comprising:
mixing a dielectric composition with a vehicle to prepare a photosensitive paste;
applying the paste to a substrate; and
baking the paste to form at least one of a first dielectric, a second dielectric, a barrier rib and a sealing portion,
wherein the dielectric composition consists of inorganic particles and a photosensitive organic silicon compound, each of which has a refractive index of 1.5 to 1.7 and is contained in an amount of 10 to 90% by weight.

6. The method according to claim 5, wherein the inorganic particles include lead-free and lead-containing glass compositions.

7. The method according to claim 5, wherein the photosensitive organic silicon compound is prepared by a sol-gel method and includes an inorganic-organic hybrid material having a network structure in which silicon-linked oxygen atoms or crosslinkable organic monomers are crosslinked with each other.

8. The method according to claim 5, wherein the photosensitive organic silicon compound is prepared by dissolving one selected from compounds of the following Formulae I to III in a mixed solvent of water and alcohol, and subjecting the solution to hydrolysis and condensation in the presence of an acidic or basic catalyst:
(OR¹)ₙSi—R²ₘ(n+m=4) (I)
(OR¹)ₙSi—(X—R³)ₘ(n+m=4) (II)
R⁴ₙSiClₘ(n+m=4) (III)
wherein R′ is a C₁-C₁₀ linear or branched alkyl group selected from methyl, ethyl, propyl and butyl, or a hydrogen atom obtained from hydrolysis of the alkyl group;
R² is a C₁-C₄ linear or branched alkyl group, a phenyl group, a phenylalkoxy group or an amine group; n is a natural number of 1 to 4;
m is an integer of 0 to 3;
X is a C₃-C₆ carbon chain;
R³ includes at least one selected from a vinyl group, a glycidoxy group and a methacrylic group; and
R⁴ includes at least one selected from a C₁-C₁₀ linear or branched alkyl group, a hydrogen atom, a phenyl group, a phenylalkoxy group, an amine group, a vinyl group, a glycidoxy group and a methacrylic group.

9. The method according to claim 8, wherein within the compounds represented by Formulae II and III, organic monomers enabling crosslinking between adjacent molecules by exposure include a vinyl group, a glycidoxy group and a methacrylic group, and the crosslinking is induced by organic polymerization.

10. The method according to claim 9, wherein the organic polymerization is carried out by the addition of a free radical organic polymerization initiator, and glycidoxy-containing monomers are ring-opening polymerized by aluminum alkoxide, titanium alkoxide, zirconium alkoxide or amine.

11. The method according to claim 5, wherein the photosensitive paste is prepared by mixing 60 to 90% by weight of the dielectric composition with 10 to 40% by weight of the vehicle.

12. The method according to claim 5, wherein the application of the paste is carried out using at least one selected from screen printing, dispensing and ink jet printing.

13. A plasma display panel comprising:
an upper panel including an upper substrate;
a lower panel including a lower substrate; and
an exhaust pipe fixed to the lower panel by an adhesive material including a thermocurable or photocurable polymer, and oriented to accommodate movement of gas through an exhaust hole in the lower panel.

14. The plasma display panel according to claim 13, wherein the adhesive material includes at least one selected from an ultraviolet-curable epoxy or acrylic resin and an organic-inorganic hybrid composite composition.

15. The plasma display panel according to claim 13, wherein the adhesive material is interposed between the lower substrate and the exhaust pipe.

16. The plasma display panel according to claim 13, wherein the exhaust pipe includes a cylindrical pipe, a first junction portion integrally formed with the cylindrical pipe and having an extended external diameter, and a second junction portion arranged on the end of the first junction portion.

17. The plasma display panel according to claim 16, wherein the adhesive material is interposed between the second junction portion and the lower substrate to fix the exhaust pipe.

18. The plasma display panel according to claim 13, wherein the adhesive material surrounds the one end of the exhaust pipe in a round-shape.

19. The plasma display panel according to claim 13, wherein the adhesive material having a thickness of 0.3 to 8 mm is positioned at one end of the exhaust pipe.

20. A method for manufacturing a plasma display panel comprising:
preparing an upper panel and a lower panel, the lower panel including a lower substrate and an exhaust hole formed on the lower substrate;
applying an adhesive material containing a thermocurable or photocurable polymer onto the lower substrate; and
fixing the exhaust pipe relative to the lower substrate using the adhesive material, the exhaust pipe being oriented to accommodate movement of gas through an exhaust hole in the lower panel.

21. The method according to claim 20, wherein the fixing of the exhaust pipe is carried out by thermocuring the adhesive material using a furnace.

22. The method according to claim 21 wherein a temperature of the furnace is 200° C. or less.

23. The method according to claim 20, wherein the fixing of the exhaust pipe is carried out by photocuring the adhesive material using an exposure system.

24. The method according to claim 23, wherein the exposure to light is carried out using a 320-360 nm lamp selected from a mercury lamp, a chemical lamp, a carbon arc lamp, a metal halide lamp and a tungsten lamp.
